(19) United States
(12) Patent Application Publication
(10) Pub. No.: US 2006/0123650 A1
(43) Pub. Date: Jun. 15, 2006

(54) Patterned masking tape

(76) Inventor: Sally Jankowski Mullins, Cheshire, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 11/011,910

(22) Filed: Dec. 14, 2004

(51) Int. Cl. B43L 7/00

(52) U.S. Cl. 33/566

(57) ABSTRACT

A patterned masking tape includes a strip of material having an adhesive coating on a surface of the strip of material. The strip of material may be wound to form a roll. At least one side edge of the strip of material is shaped to form a continuous pattern along a length of the strip of material. In use, a portion of the strip of material is removed from the roll and adhered to a surface to be decorated. Additional portions of the strip of material may be adhered to the surface to create a continuous, uninterrupted pattern of any length. The user then applies a pigmented liquid to the portion, along one or both of the side edges, and onto the surface to be decorated. The portion of the tape is removed to reveal the pattern formed by the pigmented liquid on the surface. Both side edges of the strip of material may be shaped to form half of a shape outline such that when two portions of the strip of material are placed side-by-side, the two portions form a stencil for the shape.

### BACKGROUND OF THE INVENTION

1. Field of the Invention

The present invention relates to a masking tape. More particularly, the present invention relates to a masking tape for use by painters, decorators, and others in applying a pigmented liquid (e.g., paint, stain, dye, ink, etc.) to create decorative designs or patterns on walls, ceilings, furniture, pottery, or other surfaces to be decorated.

2. Description of the Related Art

Home decorating remains a widespread hobby and a way to economically improve and beautify the home. One continuing area of interest in the field involves decorating interior or exterior walls or trim, ceilings, furniture, pottery, fabrics, dishware, paper, and other surfaces in the home using a stencil. Typically, these stencils are formed from a sheet of flexible material, such as paper or plastic, having a decorative pattern cut from a central region of the material. Once the stencil is formed, the stencil is then affixed to temporarily by means of tape or adhesive to the surface to be decorated. Paint, ink, stain, dye, or any other pigmented liquid is applied over the affixed stencil and a portion of the surface revealed by the pattern cut in the stencil. After the pigmented liquid sets or binds sufficiently to the surface, the stencil is removed, leaving only the desired decorative pattern behind.

One example of such a stencil is provided in U.S. Pat. No. 6,779,443, issued Aug. 24, 2004 to Martinez et al., which is incorporated by reference herein in its entirety. Martinez et al. describe a stencil in sheet or roll form that is adapted for stenciling large surfaces such as walls or ceilings. The stencil is a laminar structure including an outer layer of an absorbent flexible material such as paper permanently adhered to a flexible barrier layer. On the side of the barrier layer opposite the outer layer is a pressure sensitive adhesive layer that is fixed to the barrier layer, yet temporarily and releasably adheres the stencil to the surface to be decorated. The pressure sensitive adhesive may be covered with a release liner that is easily removed to expose the adhesive for application of the stencil sheet to the surface, and that prior to being removed, permits the stencil sheets to be formed conveniently into a roll or stacked without adhering to itself.

FIG. 1 depicts the use of a stencil such as that taught by Martinez et al. As shown in FIG. 1A, the stencil 10 is formed from a flexible material 12 having decorative patterns 14 cut from a central region of the material 12. One surface of the material 12 has a pressure sensitive adhesive disposed thereon. The pressure sensitive adhesive is covered with a release liner 16 that permits the material 12 to be formed into a roll 18 without adhering to itself.

When the stencil 10 is to be used, the material 12 is unrolled and the release liner 16 is removed to expose the adhesive for application. After the release liner 16 has been removed, the material 12 is adhered to a surface 20 to be decorated, as shown in FIG. 1B. Paint, ink, stain, dye, or any other pigmented liquid 22 is then applied over the affixed stencil 10 and a portion of the surface 20 revealed by the decorative pattern 14 cut in the stencil 10. After the pigmented liquid 22 sets or binds sufficiently to the surface 20, the stencil 10 is removed, leaving only the desired decorative pattern behind, as shown in FIG. 1C.

While such stencils work well for applying decorative patterns to a surface. They are not without their drawbacks and deficiencies. For example, because the decorative pattern is located in the central region of the material forming the stencil, the manufacture of the stencil requires a stamping process to form the pattern in the material, which is an additional step in the manufacturing process. Also, removing a portion of the central region of the material may weaken the material to such an extent that a reinforced material must be used to prevent tearing or deformation of the stencil. Where the stencil is formed into a roll, a release liner is typically used to prevent the material from adhering to itself and, thereby, prevents tearing or deformation of the stencil when the stencil is unrolled.

### BRIEF SUMMARY OF THE INVENTION

The above-described and other drawbacks and deficiencies are overcome or alleviated by a masking tape comprising a strip of material having an adhesive coating on a surface of the strip of material. The strip of material may be wound to form a roll. At least one side edge of the strip of material is shaped to form a continuous pattern along a length of the strip of material. For example, the pattern may be one of: a scalloped pattern, an angular pattern, a jigsaw pattern, a square pattern, a sawtooth pattern, and a wave pattern. The strip of material may be formed from a material including paper.

Where both side edges of the strip are shaped to form a pattern, the patterns on the side edges may be identical, or may be different. Where the patterns are identical, they may be offset from each other along the length of the strip of material.

In various embodiments, both side edges of the strip of material are shaped to form half of a shape outline such that when two portions of the strip of material are placed side-by-side, the two portions form a stencil for the shape.

In another aspect, a method of applying a pattern to a surface comprises: removing a first portion of a strip of material from a roll, at least one side edge of the strip of material being shaped to form a pattern along a length of the strip of material; adhering the first portion to the surface; applying a pigmented liquid to the first portion along the at least one side edge and onto the surface; and removing the first portion to reveal the pattern formed by the pigmented liquid on the surface. Additional portions of the strip of material may be adhered to the surface to create a continuous, uninterrupted pattern of any length.

In various embodiments, both side edges of the strip of material are shaped to form half of a shape outline, and the method further comprises: removing a second portion of the strip of material from the roll; adhering the second portion side-by-side with the first portion to form the shape outline; applying the pigmented liquid to the first portion, the second portion, and a portion of the surface between the first portion and the second portion; and removing the first portion and the second portion to reveal the shape formed by the pigmented liquid on the surface.

The foregoing and other objects, and features of the present invention will become more apparent in light of the following detailed description of exemplary embodiments thereof.

### BRIEF DESCRIPTION OF THE DRAWINGS

The invention will be more fully understood from the following detailed description taken in conjunction with the accompanying drawings wherein like elements are numbered alike, and in which:

FIG. 1 depicts the use of a stencil as found in the prior art;

FIG. 2 depicts top and bottom views of a roll of masking tape in accordance with a first embodiment of the present invention;

FIG. 3 depicts a method of using the masking tape of the present invention;

FIG. 4 depicts the alignment of two sections of the masking tape to create a continuous, uninterrupted pattern of any length.

FIG. 5 depicts a sheet of material cut into strips to form the masking tape of the present invention;

FIG. 6 depicts a roll of masking tape having a notch disposed therein to form the masking tape of the present invention;

FIG. 7 depicts a bottom view of a roll of masking tape having a large angular pattern in accordance with a second embodiment of the present invention;

FIG. 8 depicts a bottom view of a roll of masking tape having a small angular pattern in accordance with a third embodiment of the present invention;

FIG. 9 depicts a bottom view of a roll of masking tape having a small scalloped pattern in accordance with a fourth embodiment of the present invention;

FIG. 10 depicts a bottom view of a roll of masking tape having a jigsaw pattern in accordance with a fifth embodiment of the present invention;

FIG. 11 depicts a bottom view of a roll of masking tape having a small square pattern in accordance with a sixth embodiment of the present invention;

FIG. 12 depicts a bottom view of a roll of masking tape having a large square pattern in accordance with a seventh embodiment of the present invention;

FIG. 13 depicts a bottom view of a roll of masking tape having a zigzag pattern in accordance with an eighth embodiment of the present invention;

FIG. 14 depicts a bottom view of a roll of masking tape having a sawtooth pattern in accordance with a ninth embodiment of the present invention;

FIG. 15 depicts a bottom view of a roll of masking tape having a wave pattern in accordance with a tenth embodiment of the present invention;

FIG. 16 depicts a bottom view of a roll of masking tape having two different patterns in accordance with an eleventh embodiment of the present invention;

FIG. 17 depicts a bottom view of a roll of masking tape having offset patterns in accordance with an twelfth embodiment of the present invention;

FIG. 18 depicts a top view of a roll of masking tape having a half-shape pattern in accordance with a thirteenth embodiment of the present invention; and

FIG. 19 depicts an alternative method of using the masking tape of the present invention.

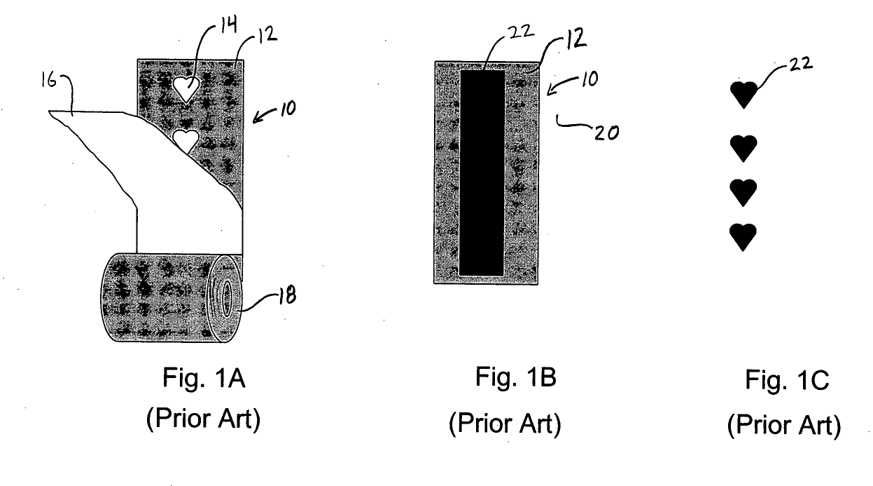

### DETAILED DESCRIPTION

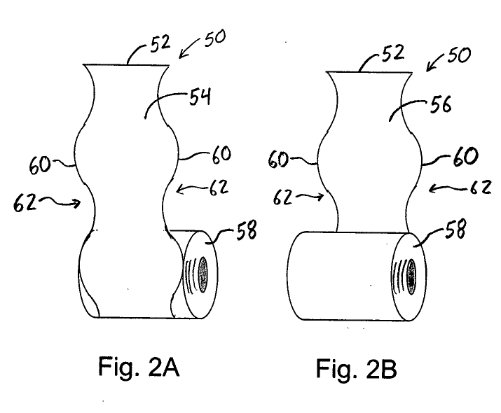

FIG. 2A and FIG. 2B depict top and bottom views of a masking tape 50 of the present invention, respectively. The masking tape 50 is formed by a strip of flexible material 52 having a top surface 54, as shown in FIG. 2A, and a bottom surface 56, as shown in FIG. 2B. A pressure-sensitive adhesive coating is applied to the bottom surface 56 of the material. The strip of material 52 may be wound upon itself to form a roll 58. The strip of material 52 has side edges 60, which extend along the entire length of the strip of material 52. In the present invention, at least one side edge 60 of the strip of material 52 is shaped to form a repeating pattern 62 along the length of the strip of material 52.

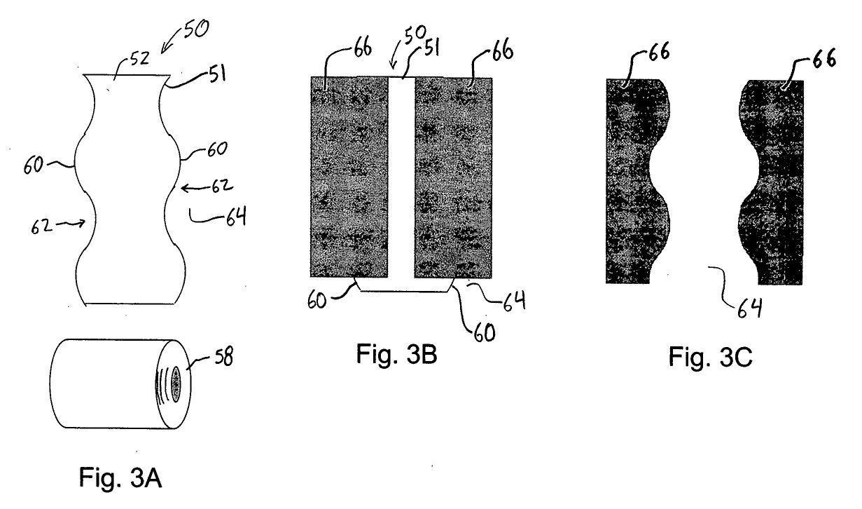

Referring to FIG. 3A, to use the masking tape 50, a portion 51 of the strip of material 52 is removed from the roll 58 and the bottom surface 56 (the surface with the pressure-sensitive adhesive) is adhered to a surface 64 to be decorated. The surface 64 may be any surface, including surfaces formed on walls, ceilings, furniture, pottery, and the like. The user then applies a pigmented liquid 66 to the portion 51 of the strip of material 52, along one or both of the side edges 60, and onto the surface 64 to be decorated, as shown in FIG. 3B. The pigmented liquid 66 may include, for example, paint, stain, dye, ink, or any other colored liquid used in decorating. After the pigmented liquid 66 sets or binds sufficiently to the surface 64, the portion 51 of the tape 50 is removed to reveal the pattern formed by the pigmented liquid 66 on the surface 64, as shown in FIG. 3C. While the embodiment of FIG. 2 and FIG. 3 depict both side edges 60 as being shaped to form the pattern 62; it will be appreciated that that the tape 50 may include one patterned side-edge 60, with the other side edge 60 being straight.

The masking tape 50 of the present invention allows a decorator to efficiently and quickly create a design pattern on a surface. For example, the decorator may apply the tape 50 to the walls of a room in either a horizontal, vertical, or diagonal direction. The decorator can then paint the room and remove the tape to reveal the patterns. The tape 50 can be used to create architecturally pleasing stripes (horizontally, vertically, and diagonally), and can be used to simulate structural features such as crown molding, baseboards, and the like.

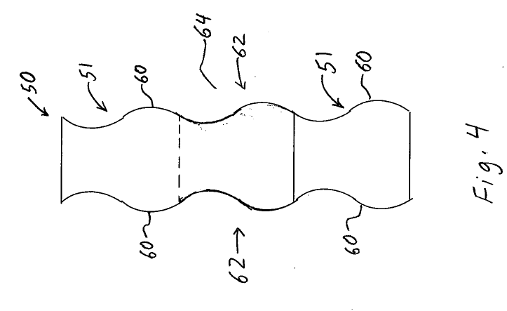

The tape 50 creates a distinct, continuous, divisional, separation between the painted and unpainted portions of the surface 64 that is uninterrupted for as long a distance as the decorator desires. Referring to FIG. 4, matching the pattern 62 at the end of one portion 51 of the tape 50 with the pattern 62 at the beginning of the next portion 51 of the tape 50 creates a continuous, uninterrupted pattern 60 having a length greater than the length of the first portion 51. Because the pattern 62 on the tape 50 is precisely repeated along the length of the tape, multiple portions 51 of tape 50 may be used to make a continuous, uninterrupted design of any length. Prior art designs, where tape is formed into a stencil by removing an interior portion of the tape, are limited to making a design of the shape and size cut into the interior portion, and cannot be used to create a continuous, uninterrupted pattern of any length.

Also, because the masking tape 50 of the present invention has patterned side edges 60 rather than a design formed within the interior of the material, as found in prior art designs, the masking tape 50 of the present invention is not as susceptible to tearing and deformation as prior art designs. As a result, the present invention can be used with conventional masking tape materials. For example, the strip of material 52 may be formed from paper (e.g., crepe paper), plastic, polymers (e.g., polyethylene film), or any other suitable material. The pressure-sensitive adhesive may be formed, for example, from a rubber-resin base or some other similar adhesive that will not damage the surface 64 to be decorated. Materials such as those used in any commercially-available masking tape may be used. For example, materials found in Scotch® brand masking tapes, commercially available from 3M Corporation of St. Paul, Minn., may be used. Other examples of materials that may be used are described in any of: U.S. Pat. No. 6,779,443, issued Aug. 24, 2004 to Martinez et al.; U.S. Pat. No. 4,129,669 issued Dec. 12, 1978 to Lopez; U.S. Pat. No. 3,929,068 issued Dec. 30, 1975 to Budden; and U.S. Pat. No. 6,436,527 issued Aug. 20, 2002 to Zimmerman, all of which are incorporated by reference herein in their entirety.

In addition, because the masking tape 50 of the present invention is not as susceptible to tearing and deformation as prior art designs, the tape 50 of the present invention may be rolled upon itself to form the roll 58 (i.e. the bottom surface 56 of the strip of material 52 is adhered to the top surface 54 of the strip of material 52 when rolled), without the use of a release liner material as found in the prior art.

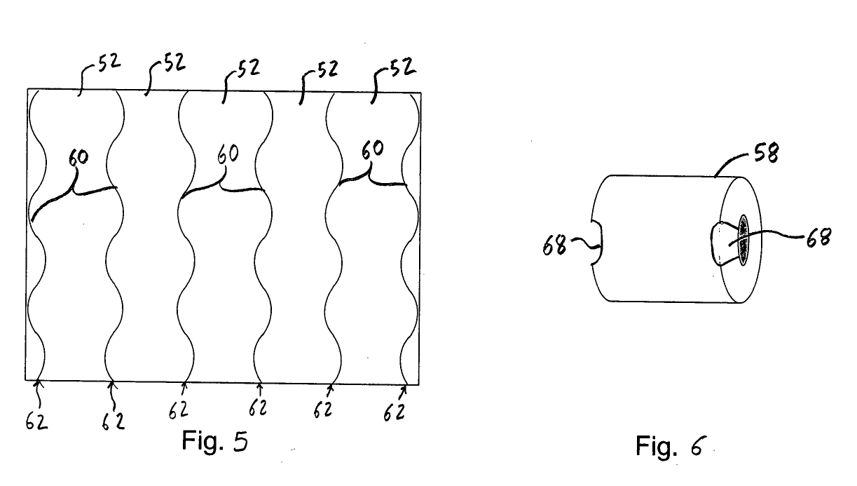

The side edges 60 of the masking tape 50 may be formed using any convenient manufacturing process. For example, referring to FIG. 2 and FIG. 5, a large sheet of material may be coated with adhesive and then cut into a plurality of strips to form the strips of material 52, which are then rolled to form individual rolls 58. Advantageously, the side edges 60 of the tape 50 are formed into the pattern 62 in the cutting process, and no additional step is needed to form the pattern 62. In comparison, prior art designs, which have a design formed within the interior of each strip of material, require an additional punching process for removing material to form the stencil outline.

In another example, referring to FIG. 2 and FIG. 6, the side edges 60 may be formed using a pre-fabricated roll of ordinary masking tape. More specifically, the roll of ordinary masking tape has substantially planar sides, which may be sawed, ground, or otherwise shaped to form a roll 58 having notches 68 in its sides. As the tape is unwound, these notches 68 result in a repeating pattern in the side edges 60 of the tape. It will be appreciated that because the diameter of the roll 58 decreases as tape 50 is removed from the roll 58, using such a method will result in a side edge pattern 60 that changes with the size of the roll 58. Accordingly, this method is less preferred than that described with reference to FIG. 5.

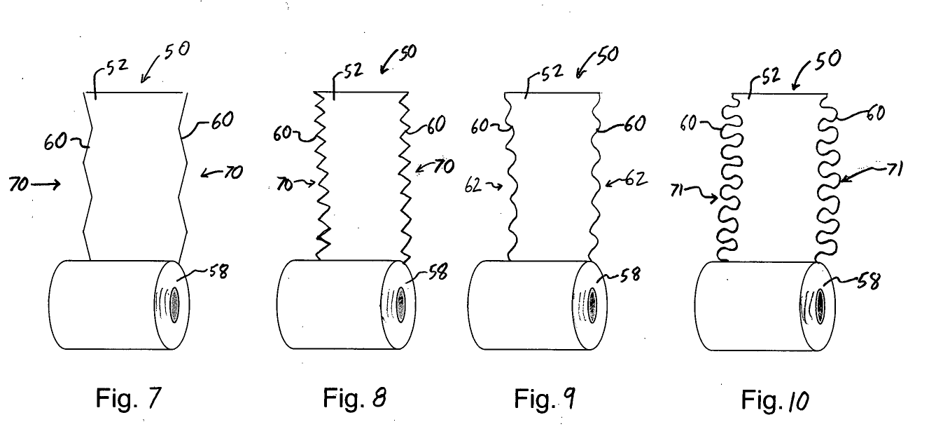

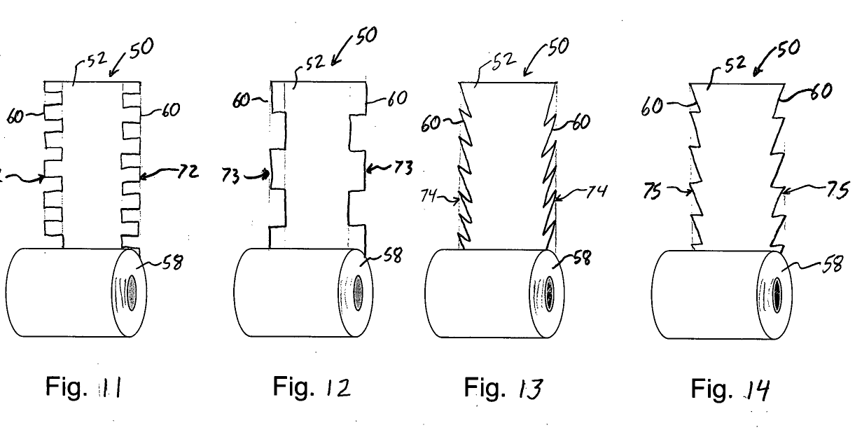

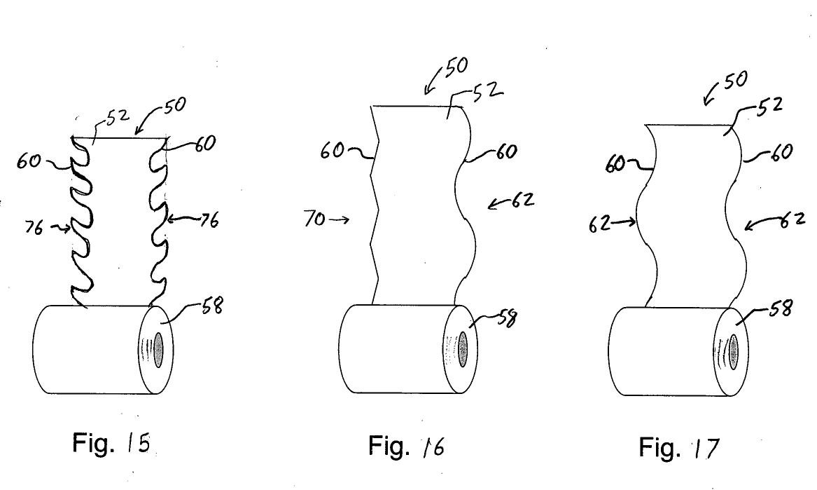

Referring again to FIG. 2, in the embodiment shown, the side edges 60 of the tape 50 are shaped to form a scalloped pattern 62. It is contemplated that any two-dimensional geometric pattern may be used. For example, as shown in FIG. 7, an angular (equilateral triangle) pattern 70 may be used. It is also contemplated that the pattern may be of any size. For example, as shown in FIG. 8 and FIG. 9, respectively, a relatively small angular pattern 70 or a relatively small scalloped pattern 62 may be used. Examples of other patterns that may be used are depicted in FIGS. 10-15, which include: a jigsaw (interlocking curves) pattern 71; a square pattern 72, which may be used to simulate bricks; a large square pattern 73, which may be used to simulate blocks; a zigzag (lightning bolt) pattern 74; a sawtooth pattern 75; a wave (ocean wave) pattern 76. The patterns of FIGS. 10-15 are provided for example only, and it is contemplated that other patterns may be used.

Where both side edges 60 of the strip of material 52 are shaped to form a pattern, the patterns on the side edges 60 may be identical. For example, as shown in FIG. 7, both side edges 60 are formed as the angular pattern 70. Alternatively, the side edges 60 may form different patterns, as shown in FIG. 16, where, for example, one side edge 60 forms the angular pattern 70 and the other side edge 60 forms the scalloped pattern 62. Where the patterns are identical on both side edges 60, the patterns may be aligned with each other, as shown in FIG. 2, such that the pattern on one side edge 60 is a mirror image of the pattern on the other side edge 60. Alternatively, the patterns on the side edges 60 may be offset from each other along the length of the strip of material 52, as shown in FIG. 17. With the scalloped pattern 62 shown in FIG. 17, this results in a masking tape 50 having a wavy appearance.

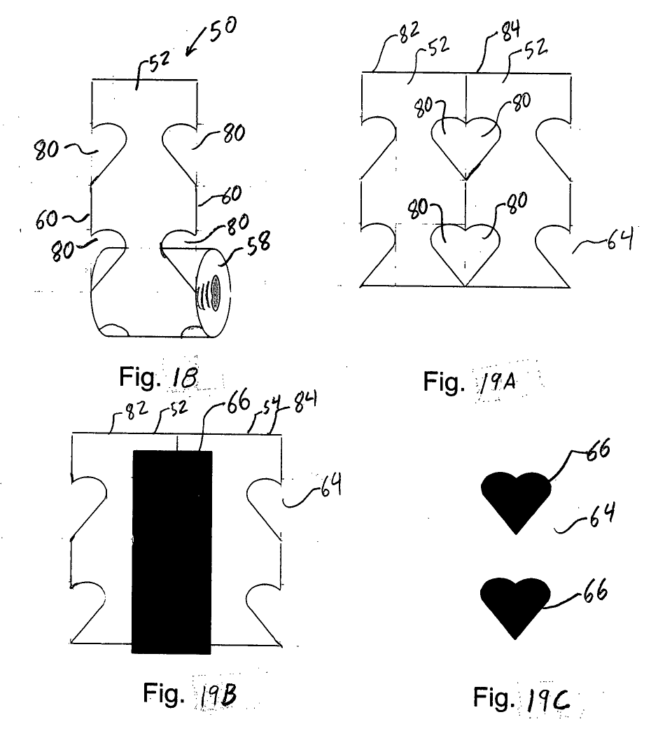

FIG. 18 depicts yet another embodiment, wherein both side edges 60 of the strip of material 52 are shaped to form half of a shape outline 80. When two portions of the strip of material 52 are placed side-by-side, as depicted in FIG. 19A, the two portions form a stencil for the shape. In the embodiment shown, the shape formed by the two portions of masking tape 50 is a heart. It is contemplated that any two-dimensional geometric shape may be used.

Referring to FIG. 18 and FIG. 19A, to use the masking tape 50 of FIG. 18, a first portion 82 of the strip of material 52 is removed from the roll 58 and the bottom surface (the surface with the pressure-sensitive adhesive) of the first portion 82 is adhered to the surface 64 to be decorated. A second portion 84 of the strip of material 52 is then removed from the roll 58 and the bottom surface of the second portion 84 is adhered to the surface 64 to be decorated. The user then applies the pigmented liquid to the first portion 82, the second portion 84, and the exposed surface 64 between the first portion 82 and the second portion 84, as shown in FIG. 19B. After the pigmented liquid 66 sets or binds sufficiently to the surface 64, the first and second portions 82, 84 are removed to reveal the shape formed by the pigmented liquid 66 on the surface 64, as shown in FIG. 19C.

The embodiment of FIG. 18 and FIG. 19 provides a result similar to that found in the prior art but with the aforementioned advantages of the present invention.

While the present invention finds particular utility for use by painters or decorators, those skilled in the art will recognize that the invention may have other applications and could be utilized, for example, for arts and crafts and other paint and design related purposes.

It should be understood that any of the features, characteristics, alternatives or modifications described regarding a particular embodiment herein may also be applied, used, or incorporated with any other embodiment described herein.

A number of embodiments of the present invention have been described. Nevertheless, it will be understood that various modifications may be made without departing from the spirit and scope of the invention. Accordingly, other embodiments are within the scope of the following claims.

1. A masking tape comprising:
a strip of material having a surface and two side edges disposed on opposite sides of the surface;
an adhesive coating disposed on the surface of the strip of material; and
wherein each side edge of the strip of material is shaped to form a repeating two-dimensional geometric pattern along a length of the strip of material.

2. The masking tape of claim 1, wherein the strip of material is adhered to itself in a roll.

3. The masking tape of claim 1, wherein the repeating two-dimensional geometric pattern is one of: a scalloped pattern, an angular pattern, a jigsaw pattern, a square pattern, a sawtooth pattern, and a wave pattern.

4. The masking tape of claim 1, wherein both side edges of the strip of material are shaped to form identical repeating two-dimensional geometric patterns along the length of the strip of material.

5. The masking tape of claim 4, wherein the identical repeating two-dimensional geometric patterns are offset from each other along the length of the strip of material.

6. The masking tape of claim 1, wherein both side edges of the strip of material are shaped to have different repeating two-dimensional geometric patterns along the length of the strip of material.

7. The masking tape of claim 1, wherein both side edges of the strip of material forming the roll are shaped to form half of a shape outline such that when two portions of the strip of material are placed side-by-side, the two portions form a stencil for the shape.

8. A method of applying a pattern to a surface, the method comprising:
adhering a first portion of a strip of material to a surface, the strip of material including a surface and two side edges disposed on opposite sides of the surface, wherein each side edge of the strip of material is shaped to form a repeating two-dimensional geometric pattern along a length of the strip of material;
applying a pigmented liquid to the first portion along each side edge and onto the surface; and
removing the first portion to reveal the pattern formed by the pigmented liquid on the surface.

9. The method of claim 8, further comprising:
removing the first portion of the strip of material from a roll in which the strip of material is adhered to itself.

10. The method of claim 8, wherein the repeating two-dimensional geometric pattern is: a scalloped pattern, an angular pattern, a jigsaw pattern, a square pattern, a sawtooth pattern, and a wave pattern.

11. The method of claim 8, wherein both side edges of first strip of material are shaped to form identical repeating two-dimensional geometric patterns along the length of the strip of material.

12. The method of claim 11, wherein the identical repeating two-dimensional patterns are offset from each other along the length of the strip of material.

13. The method of claim 8, wherein both side edges of the strip of material are shaped to have different repeating two-dimensional geometric patterns along the length of the strip of material.

14. The method of claim 8, wherein both side edges of the strip of material are shaped to form half of a shape outline, and the method further comprises:
adhering a second portion of the strip of material onto the surface in side-by-side relationship with the first portion such that the second portion contacts the first portion to form the shape outline;
applying the pigmented liquid to the first portion, the second portion, and a portion of the surface between the first portion and the second portion; and
removing the first portion and the second portion to reveal the shape formed by the pigmented liquid on the surface.

15. The method of claim 8, further comprising:
adhering a second portion of the strip of material to the surface such that the repeating two-dimensional geometric pattern on the second portion is aligned with the repeating two-dimensional geometric pattern on the first portion to create a continuous, uninterrupted pattern having a length greater than a length of the first portion;
applying the pigmented liquid to the first portion, the second portion, and the surface; and
removing the first portion and the second portion.

16. A masking tape comprising:
a strip of material including a surface and two side edges disposed on opposite sides of the surface;
an adhesive coating disposed on the surface of the strip of material, the strip of material being wound into a roll in which the strip of material is adhered to itself; and
wherein each side edge of the strip of material is shaped to form a repeating two-dimensional geometric pattern along a length of the strip of material, the repeating two-dimensional geometric pattern being one of: a scalloped pattern, an angular pattern, a jigsaw pattern, a square pattern, a sawtooth pattern, and a wave pattern.

17. The masking tape of claim 16, wherein both side edges of the strip of material are shaped to form identical repeating two-dimensional geometric patterns along the length of the strip of material.

18. The masking tape of claim 17, wherein the identical repeating two-dimensional geometric patterns are offset from each other along the length of the strip of material.

19. The masking tape of claim 17, wherein both side edges of the strip of material are shaped to have different repeating two-dimensional geometric patterns along the length of the strip of material.

20. The masking tape of claim 17, wherein the strip of material is formed from a material including paper.
